(19) United States
(12) Patent Application Publication
(10) Pub. No.: US 2009/0119114 A1
(43) Pub. Date: May 7, 2009

(54) Systems and Methods for Enabling Customer Service

(76) Inventors: David Alaniz, Tucker, GA (US); Richard Amos, Acworth, GA (US); Shawn Roseland, Dacula, GA (US); Christopher Bailey, Atlanta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/934,568

(22) Filed: Nov. 2, 2007

(51) Int. Cl. G06Q 10/00

(52) U.S. Cl. 705/1

(57) ABSTRACT

A method for enabling customer service includes providing a first portion of a flow chart including a flow chart component corresponding to a first task and a flow chart component corresponding to a second task. The flow chart may correspond to a customer service process comprising several tasks. A list of steps corresponding to the first task depicted in the flow chart is also provided. User input indicating completion of the first task is then received. Responsive to receiving the user input, a second portion of the flow chart is provided including a flow chart component corresponding to the second task and a flow chart component corresponding to a third task. The second portion of the flow chart includes at least one flow chart component that is not part of the first portion of the flow chart.

### TECHNICAL FIELD

This application relates generally to the field of user interfaces. More specifically, this application relates to systems and methods for enabling customer service.

### BACKGROUND

Customer service is the provision of service to customers before, during and after a purchase. Its importance varies by product, industry and customer. As an example, an expert customer might require less pre-purchase service (e.g., advice) than a novice. In many cases, customer service is more important if the purchase relates to a “service” as opposed to a “product”. Customer service may be provided by a person (e.g., sales and service representative), or by automated means called self-service. Examples of self service are Internet sites. Customer service is normally an integral part of a company's customer value proposition.

Customer service often involves going beyond the expectation of the customers. A company may attempt to differentiate itself from its competition through the provision of better customer service. The consistent delivery of superior service typically requires the careful design and execution of a whole system of activities that includes people, technology, and processes. The rewards of consistently delivering superior customer service will include improved revenue from customers that are satisfied with the service provided.

Technology has made available a wide range of customer service tools. They range from support websites and the ability to have live chats with technical staff to databases tracking individual customers' preferences and purchase history, and tailoring products and service responses based on the customer data. Specialist software that is designed for the tracking of service levels and for helping recognize areas for improvement are often integrated into other enterprise operational software tools. Customer service provided over the telephone varies widely in quality and particularly in the wait times experienced by customers. The extremely long wait times experienced when attempting to reach large companies is a common experience shared by many customers.

### SUMMARY

Systems, methods, and computer program products for enabling customer service are provided. Exemplary embodiments include providing a first portion of a flow chart including a flow chart component corresponding to a first task and a flow chart component corresponding to a second task. The flow chart may, for example, correspond to a customer service process that includes several tasks. A list of steps corresponding to the first task depicted in the flow chart is also provided. User input indicating completion of the first task is then received. After receiving the user input, a second portion of the flow chart is provided including a flow chart component corresponding to the second task and a flow chart component corresponding to a third task. The second portion of the flow chart includes at least one flow chart component that is not part of the first portion of the flow chart. For example, as each task is completed, a different portion of the flow chart is provided that illustrates a previous task, a current task, and a future task. A list of steps corresponding to a current task (e.g., the second task) may also be provided.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating components of a user interface screen, in accordance with exemplary embodiments.

FIG. 2 is a schematic diagram illustrating an example of a user interface screen, in accordance with exemplary embodiments.

FIG. 3 is a schematic diagram illustrating another example of a user interface screen, in accordance with exemplary embodiments.

FIG. 4 is a schematic diagram illustrating a further example of a user interface screen, in accordance with exemplary embodiments.

FIGS. 5A and 5B illustrate an example of a change in the flow chart section of a user interface screen, in accordance with exemplary embodiments.

FIGS. 5C and 5C illustrate another example of a change in the flow chart section of a user interface screen, in accordance with exemplary embodiments.

FIG. 6 is a block diagram illustrating a customer service system, in accordance with exemplary embodiments.

FIG. 7 is a flow chart illustrating a method for providing flow chart components, in accordance with exemplary embodiments.

FIG. 8 is a flow chart illustrating another method for providing a user interface screen, in accordance with exemplary embodiments.

FIG. 9 is a block diagram illustrating the agent computer, in accordance with exemplary embodiments.

### DETAILED DESCRIPTION

The following detailed description is directed to methods, systems, and computer-readable media for enabling customer service. In the following detailed description, references are made to the accompanying drawings that form a part hereof, and which are shown by way of exemplary embodiments and implementations.

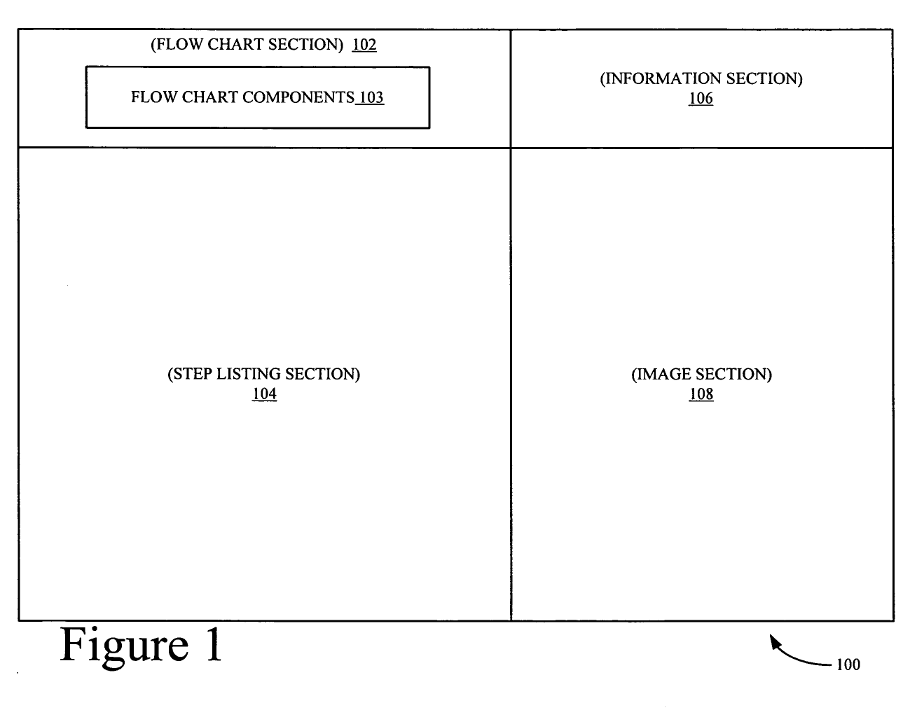

FIG. 1 is a block diagram illustrating components of a user interface screen 100, in accordance with exemplary embodiments. The screen 100 includes a flow chart section 102, a step listing section 104, an information section 106, and an image section 108. The flow chart section 102 includes flow chart components 103 corresponding to a customer service process. The customer service process may correspond to tasks to be completed by a customer service representative and/or a customer communicating with such representative. For example, a customer may telephone a call center to receive help in resolving a communication problem the customer is experiencing with customer premises equipment (CPE). The customer may then be directed to a customer service agent who will assist the customer in resolving the problem. The customer service agent may then instruct the customer to take certain steps toward diagnosing and/or resolving the customer's problem. For example, the customer service agent may advice the customer to verify certain settings on the CPE and/or whether certain software associated with the CPE is installed and/or operating properly. If the customer service process results in determining that the problem will require a technician to visit the customer premises, then the customer service agent may initiate the dispatch of a technician to the customer premises. The customer service process may additionally or alternatively involve the initiation of shipment of other CPE to the customer premises. A person of ordinary skill in the art will recognize that many other customer service scenarios are possible within the scope of this disclosure.

The step listing section 104 can list steps corresponding to one of the flow chart components 103. The flow chart components 103 may include components corresponding to a current task, a previous task, and a future task. Where a current task may lead to more than one possible subsequent tasks, the flow chart components 103 may include components corresponding to a current task and to the possible subsequent tasks, as will be discussed in more detail below.

The image section 108 can display an image corresponding to one of the steps listed in the step listing section 104. An image shown in the image section 108 may be, for example, a user interface window or a screen shot similar to what a customer is viewing during the customer service session. The information section 106 can display information related to the process corresponding to the flow chart components 103. The information in the information section 106 may identify, for example, certain tasks that were completed, the time the tasks were completed and/or the time taken to complete the tasks.

When a task is completed, a user, such as a customer service agent, or a customer may select another task depicted in the flow chart section 102. A task depicted in the flow chart section 102 may be selected by, for example, using a mouse to click on a corresponding flow chart component from the flow chart components 103. Selecting a task depicted in the flow chart section 102 causes the screen 100 to be updated accordingly. For example, the following updates may take place: the flow chart components 103 in the flow chart section 102 are updated, another list of steps corresponding to the next flow chart component is provided in the step listing section 104, a new image corresponding to one of the steps listed in the step listing section 104 is displayed in the image section 108, and/or an indication of the completed task is provided in the information section 106.

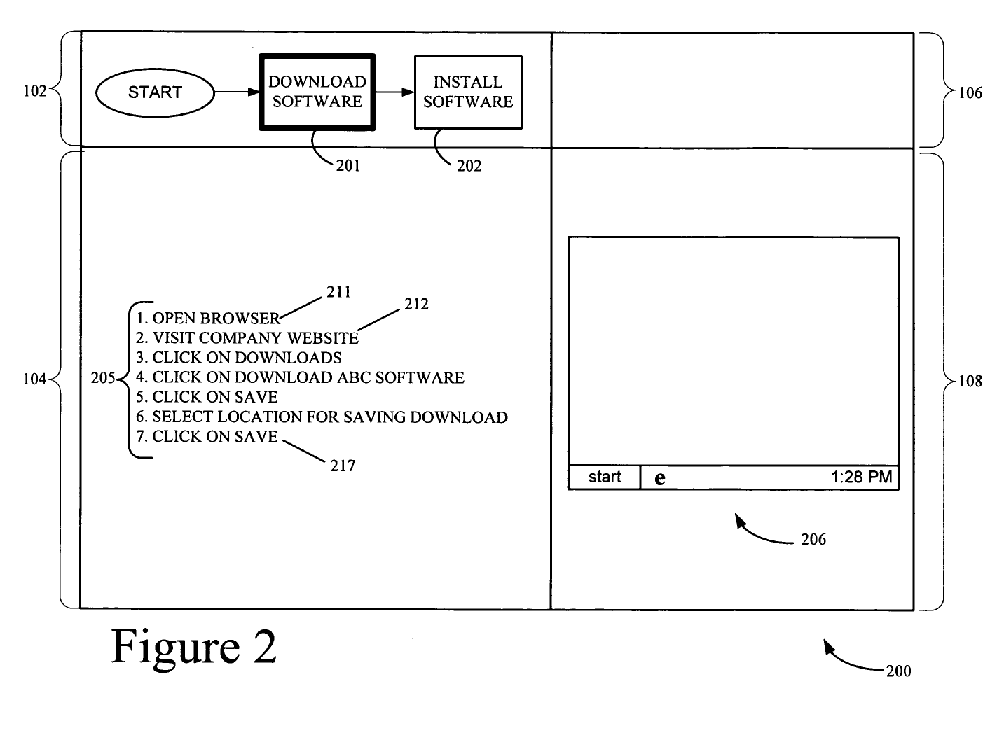

The user interface screens depicted in FIGS. 2-4 are configured to facilitate an exemplary process that involves downloading, installing, and running a certain software program. FIG. 2 is a schematic diagram illustrating an example of a user interface screen 200, in accordance with exemplary embodiments. The flow chart section 102 includes flow chart components 201 and 202 of a flow chart corresponding to a customer service process. As illustrated in FIG. 2, the customer service process of the flow chart section 102 is associated with accessing and installing software. The step listing section 104 includes a list of steps 205 corresponding to the flow chart component 201. In this example, the flow chart component 201 corresponds to the task of downloading software, and the list of steps 205 includes a first step 211, a second step 212, a third step, a fourth step, a fifth step, a sixth step, and a seventh step 217 as follows:

1. Open browser

2. Visit company website

3. Click on downloads

4. Click on download ABC software

5. Click on save

6. Select location for saving download

7. Click on save

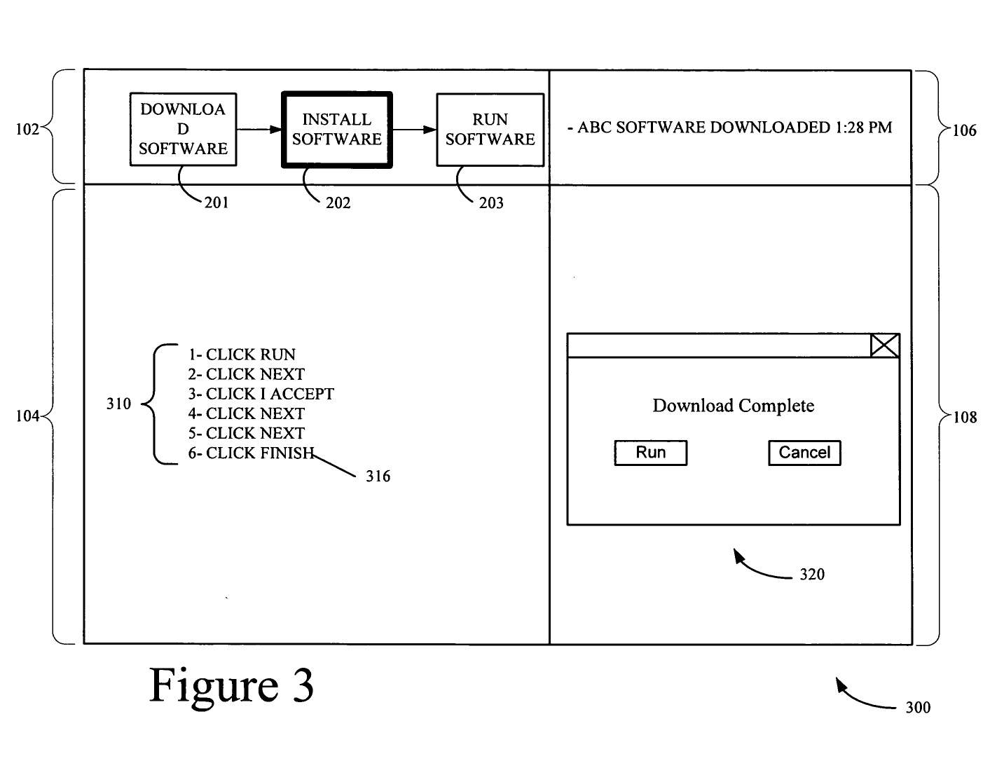

A desktop user interface window 206 having similar components to an interface window that a customer may be viewing, is displayed in the image section 108. As each step is performed by the agent or customer, the agent can provide input confirming the completion of the step. For example, the agent may select a subsequent step listed in the step listing section 104. Alternatively, the agent may select another option shown in the user interface screen 200, such as by clicking on a “Next” or “Continue” option, depending on a desired implementation. After a step listed in the step listing section 104 is confirmed as having been completed, other areas in the screen 200 are updated accordingly. For example, after the agent indicates that the first step 211 has been completed, an image corresponding to the second step 212 (visit company website) is displayed in the image section 108. The image displayed in the section 108 may be, for example, a screen shot corresponding to a web browser or a functional web browser window that would help illustrate how the second step 212 would be performed. As another example, after the agent indicates that the seventh step 217 has been completed, then the screen 200 may be updated so as to assist the agent and/or customer in implementing a subsequent task, such as a task corresponding to the flow chart component 202. An example of how the screen 200 may be updated is shown in FIG. 3.

FIG. 3 is a schematic diagram illustrating an example of a user interface screen 300, in accordance with exemplary embodiments. After the steps in the list of steps 205 corresponding to the flow chart component 201 have been completed, a list of steps 310 corresponding to the flow chart component 202 is provided in the step listing section 104. The flow chart component 202 corresponds to installing the program downloaded pursuant to the task corresponding to the flow chart component 201. In this example, the list of steps 310 includes a first step, a second step, a third step, a fourth step, a fifth step, and a sixth step 316 as follows:

1—Click run

2—Click next

3—Click I accept

4—Click next

5—Click next

6—Click finish

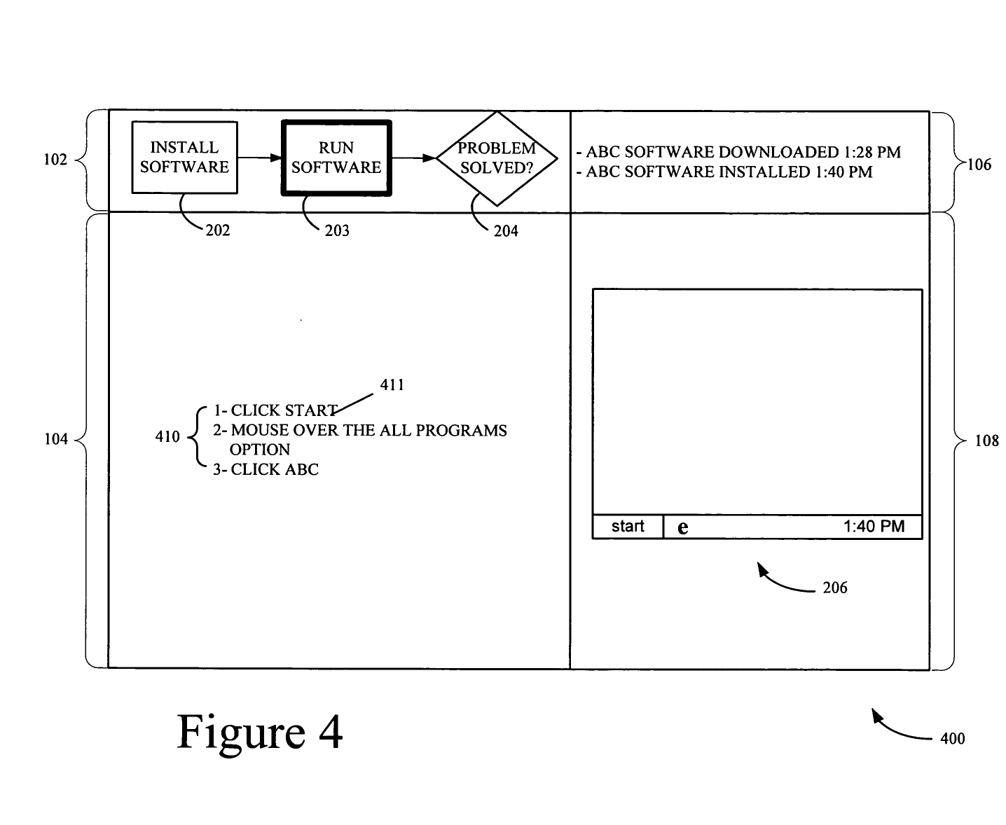

Various sections of the screen 300 are updated as compared to the screen 200: the flow chart section 102 is updated to show the flow chart components 201, 202, and a flow chart component 203; the information section 106 is updated to reflect that the task associated with the flow chart component 201 has been completed. For example, the information section 106 may indicate that the ABC software has been downloaded as well as the date and/or time that the download was completed. Further, the image section 108 is updated to show a download user interface window 320. When the agent indicates that the sixth step 316 has been completed, then the screen 300 is updated as shown, for example, in FIG. 4. An agent can indicate that a step or task has been completed by selecting (e.g., via mouse or keyboard input) a subsequent step or task via a current user interface screen, such as the screen 300.

FIG. 4 is a schematic diagram illustrating an example of a user interface screen 400, in accordance with exemplary embodiments. After the task corresponding to the flow chart component 202 is completed, a list of steps 410 corresponding to the flow chart component 203 is provided in the step listing section 104. The flow chart component 203 corresponds to the task of running the program that was installed pursuant to the task corresponding to the flow chart component 201 and downloaded pursuant to the task corresponding to the flow chart component 202 by the customer. In this example, the list of steps 410 includes a first step 411, a second step, and a third step as follows:

1—Click start

2—Mouse over the all programs option

3—Click ABC

Various sections of the screen 400 are updated as compared to FIG. 3: the flow chart section 102 is updated to show the flow chart components 203 and a flow chart component 204; the information section 106 is updated to reflect that the task associated with the flow chart components 202 has been completed. For example, the information section 106 may indicate that the ABC software has been installed. A desktop user interface window 206 having similar components to an interface window that the customer may be viewing, is displayed in the image section 108. The customer service agent may instruct the customer to click on the “Start” button on the customer's user interface to perform step 411. The sections 102, 104, 106 and 108 continue to be updated after each task is completed until the process corresponding to the flow chart components shown in flow chart section 102 is completed.

A person of ordinary skill in the art will recognize that many alternative processes may be facilitated or enabled using the systems and methods described herein. Non-limiting examples, among others, of such processes include a process for diagnosing a communication problem involving customer premises equipment, a process for purchasing a customer premises equipment, or a process for using or configuring customer premises equipment. Furthermore, alternative embodiments include user interface screens or windows that have different configuration and/or content than those shown in FIGS. 2-4.

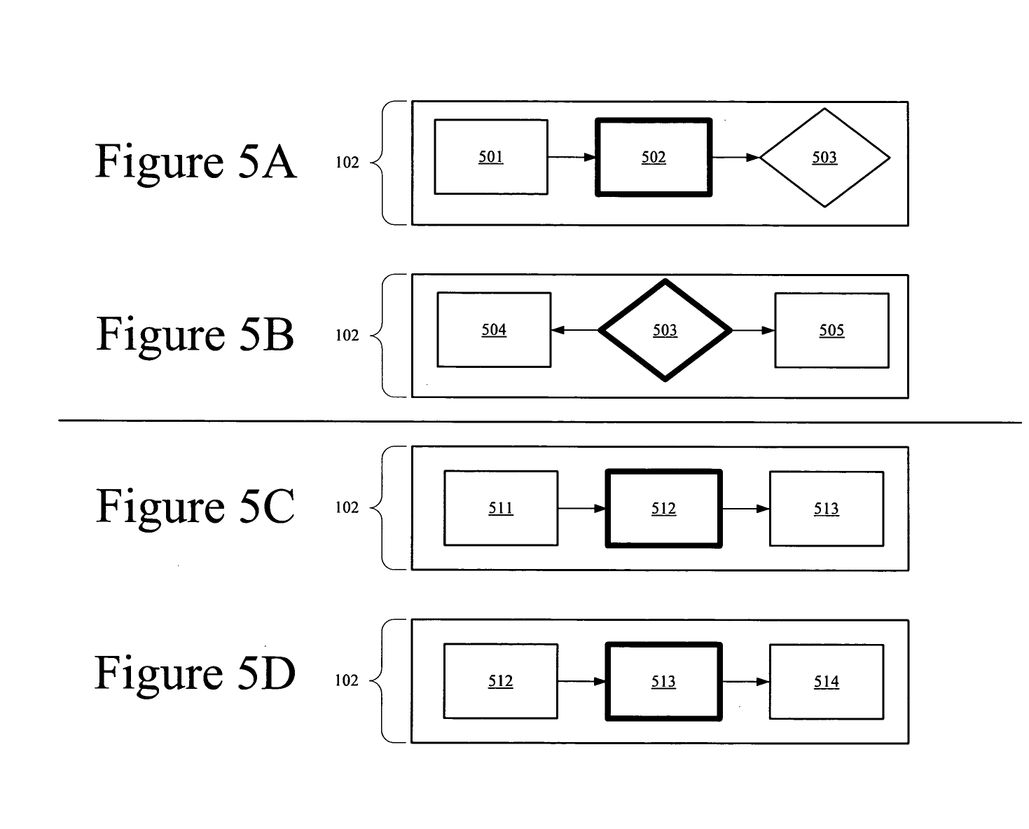

FIGS. 5A and 5B illustrate a change in the flow chart section 102 of a user interface screen, such as the user interface screen 100, in accordance with exemplary embodiments. As shown in FIG. 5A, the flow chart section 102 includes flow chart components 501, 502, and 503. The flow chart component 502 corresponds to a current task being performed by, for example, a customer service agent and/or a customer. To indicate that the flow chart component 502 is a current task being performed, the component may be highlighted, enlarged, or modified in any other manner to indicate that focus is currently on the component. After the agent indicates that the step corresponding to the flow chart component 502 has been completed, then the flow chart section 102 is updated to show the flow chart component 503 and components 504 and 505 as illustrated in FIG. 5B. According to exemplary embodiments, since the task corresponding to the flow chart component 502 has been completed, focus shifts to the next component, which in this case is flow chart component 503, as illustrated in FIG. 5B.

The flow chart component 503 may correspond to a task having more than one possible outcome. For example, the process described in the flow chart section 102 moves to a task corresponding to the flow chart component 505 if the task corresponding to the flow chart component 503 has a first outcome or to the flow chart component 504 if such task has a second outcome. For example, the flow chart component 503 may correspond to a decision-based task for determining if a certain problem has been solved. In such example, the flow chart component 505 may correspond to a task to be performed if the problem has been solved, whereas the flow chart component 504 may correspond to a task to be performed if the problem has not been solved.

FIGS. 5C and 5D illustrate another change in the flow chart section 102, in accordance with exemplary embodiments. As shown in FIG. 5C, the flow chart section 102 includes flow chart components 511, 512, and 513. The flow chart component 512 corresponds to a current task being performed by, for example, customer service agent and/or a customer. After the agent indicates that the step corresponding to the flow chart component 512 has been completed, then the flow chart section 102 is updated to show the flow chart components 512, 513, and a flow chart component 514 as illustrated in FIG. 5D. The flow chart component 513 becomes the component corresponding to a current task being performed by the agent and/or customer as indicated by the highlighting associated with the flow chart component 513.

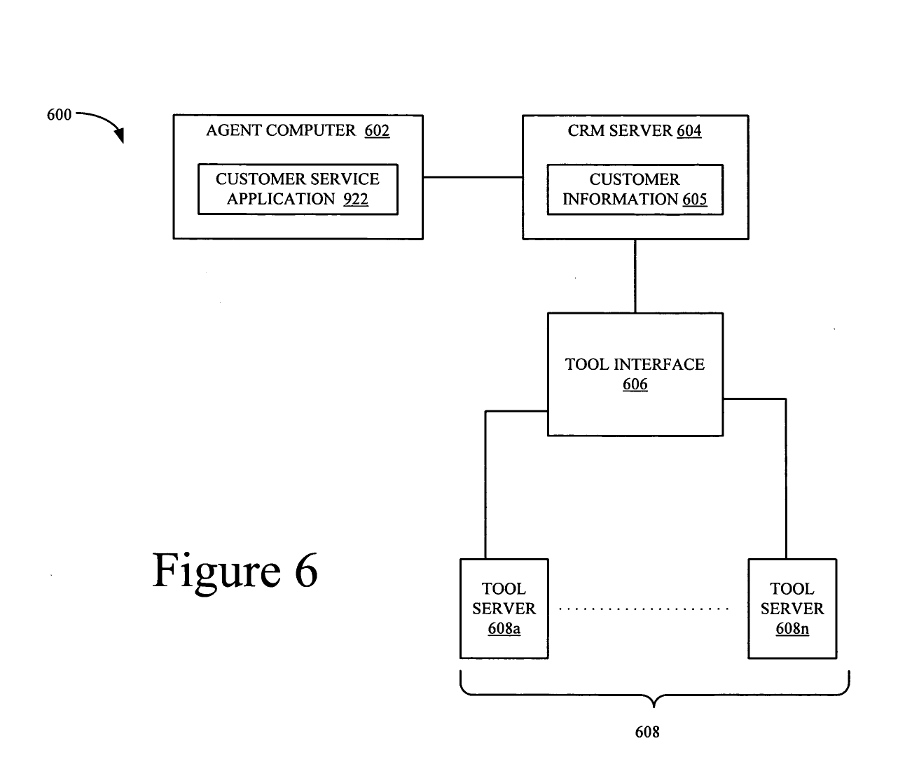

FIG. 6 is a block diagram illustrating a customer service system 600, in accordance with exemplary embodiments. The customer service system 600 includes an agent computer 602 that is coupled, directly or via a network, to a customer relationship management (CRM) server 604. The CRM server 604 is coupled, directly or via a network, to a tool interface 606. The tool interface 606 is coupled, directly or via a network, to tool servers 608 (e.g., tool servers 608a-608n). The agent computer 602 includes a customer service application 922 configured to enable a customer service agent to provide customer service to a customer. For example, the customer service application 922 may provide a customer service agent with the user interface screen 100 that includes the flow chart section 102, the step listing section 104, the information section 106, and the image section 108. The CRM server 604 includes customer information 605 such as name, address, and services subscribed-to by the customer. The CRM server 604 provides the agent computer 602 with access to customer information 605 and to the tool interface 606.

According to exemplary embodiments, the tool servers 608 provide the agent computer 602 with software tools via the tool interface 606 and the CRM server 604. Examples of software tools provided by the tool servers 608 include: a customer premises equipment (CPE) tool for initiating the shipping of CPE to customers, a dispatch tool for initiating the dispatch of technicians to customer premises, an eRepair™ tool for testing communication lines, a customer information tool (CIT) for providing customer information, and a deep packet inspection (DPI) tool for monitoring customer communications. In exemplary embodiments, interactive screens, such as the screens 206, 320, displayed in the image section 108 are provided by one or more of the tool servers 608. For example, a CPE tool may provide a user interface window in the image section 108 having a selectable option for requesting a modem to be shipped to a customer. As another example, a dispatch tool may provide a user interface window in the image section 108 having a selectable option for requesting a technician to be dispatched to a customer premises.

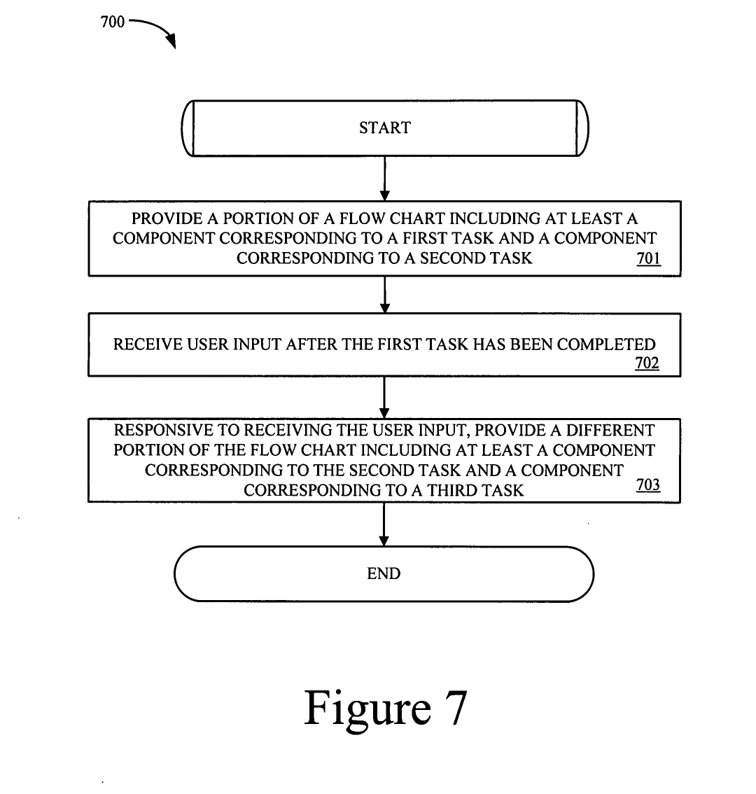

FIG. 7 is a flow chart illustrating a method 700 for providing flow chart components, in accordance with exemplary embodiments. As indicated in step 701, a portion of a flow chart is provided to a user interface, such as the interface 100, including at least a component corresponding to a first task and a component corresponding to a second task. The portion of the flow chart may be provided by, for example, the customer service application 922. The flow chart components may be provided, for example, in the flow chart section 102. Furthermore, the flow chart components may correspond, for example, to tasks in a customer service process. A customer service agent may select a suitable customer service process to be performed based on, for example, information received by the customer service agent from a customer. The flow chart components may be provided to the customer service agent, responsive to, for example, the customer service agent selecting a user interface option corresponding to the desired customer service process.

User input is received at the interface 100 after the first task has been completed, as indicated in step 702. The user input may be achieved, for example, by a user selecting (e.g., via a mouse or keyboard) the flow chart component corresponding to the second task. Alternatively, the user may select an option indicating that the first task has been completed. Then, responsive to receiving the user input, a different portion of the flow chart is provided to the user interface 100 including at least the component corresponding to the second task and a component corresponding to a third task, as indicated in step 703. The different portion of the flow chart may be provided by, for example, the customer service application 922. The method 700 may continue by providing additional flow chart components to the user interface 100 corresponding to subsequent tasks until the end of the flow chart is reached or the process is otherwise ended. For example, after the second task is completed and additional user input is received, a flow chart component corresponding to a fourth task is provided. A predetermined number of flow chart components (e.g., 2, 3, 4, or 5) may be displayed to a user via the user interface 100 at any given time. The number of flow chart components presented may vary depending on whether the user is at a beginning or end of a process represented by the flow chart. For example, at the beginning of a process, the user may be presented with flow chart components corresponding to the first two tasks of the process. Similarly, at the end of a process, the user may be presented with flow chart components corresponding to the last two tasks of the process. However, at other times during the process, the user may, for example, be presented with flow chart components corresponding to three tasks in the process: a current task, a previous task, and a future task. Where a current task may result in alternative subsequent tasks, flow chart components corresponding to such subsequent tasks may be displayed in conjunction to the flow chart component corresponding to the current task. Note that other implementations may include simultaneously displaying a different number of flow chart components than those mentioned above.

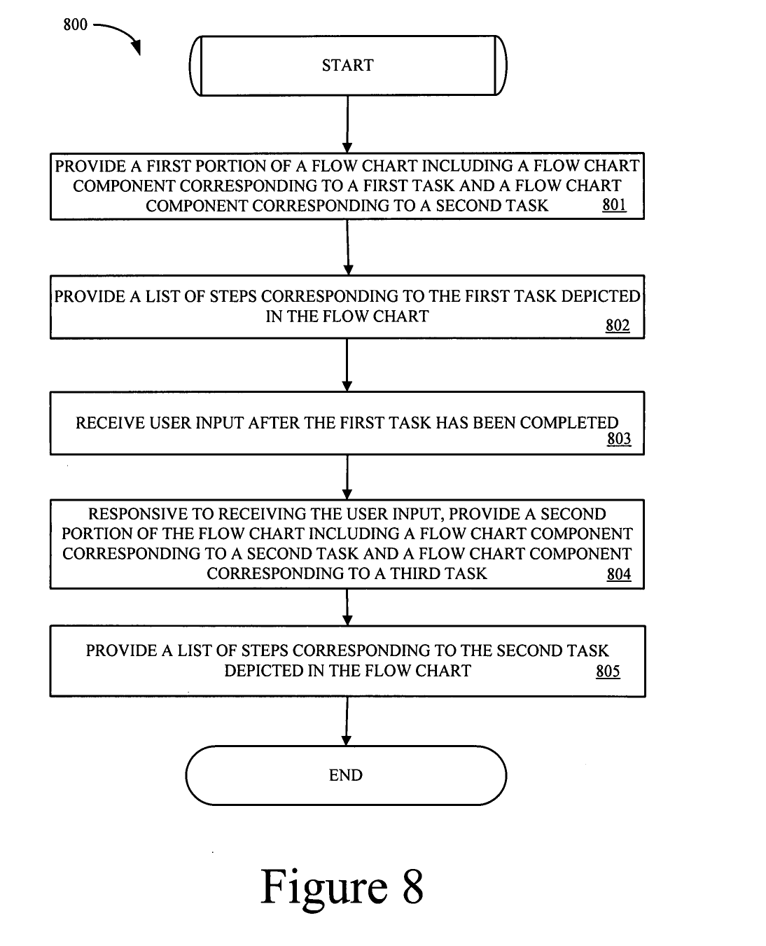

FIG. 8 is a flow chart illustrating another method 800 for providing the user interface screen 100, in accordance with exemplary embodiments. As indicated in step 801, a first portion of a flow chart is provided to the user interface 100 including a flow chart component corresponding to a first task and a flow chart component corresponding to a second task. The portion of the flow chart may be provided by, for example, the customer service application 922. The flow chart components may be presented, for example, in the flow chart section 102. Furthermore, the flow chart components may correspond, for example, to a customer service process. A customer service agent may select a suitable customer service process to be performed based on, for example, information received by the customer service agent from a customer.

The customer service process may comprise a certain number of tasks with each task comprising a certain number of steps. The steps that form each task may be performed by a customer service agent and/or a customer who is communicating with the customer service agent. A list of steps corresponding to the first task depicted in the flow chart is provided, as indicated in step 802. The list of steps may be displayed, for example, in the step listing section 104.

User input is then received at the user interface 100 after the first task has been completed, as indicated in step 803. For example, when the steps corresponding to the first task have been completed, a customer service agent may provide user input selecting a subsequent task or indicating that the steps corresponding to the first task have been completed. Responsive to receiving the user input, a second portion of the flow chart is provided including the flow chart component corresponding to the second task and a flow chart component corresponding to a third task, as indicated in step 804. A list of steps corresponding to the second task depicted in the flow chart is also provided, as indicated in step 805.

The list of steps provided pursuant to the method 800 may be displayed, for example, in the step listing section 104. The image section 108 can display an image corresponding to one of the steps listed in the step listing section 104. An image shown in the image section 108 may be, for example, a user interface window or a screen shot similar to what a customer is viewing during the customer service session. The information section 106 can display information related to the process corresponding to the flow chart components 103. The information in the information section 106 may identify, for example, certain tasks that were completed, the date and/or time the tasks were completed and/or the time taken to complete the tasks.

The method 800 may be implemented where, for example, a customer contacts a service provider regarding a customer service issue. The customer service issue may involve, for example, a communication problem, such as, for example, a digital subscriber line (DSL) communication problem being experience by the customer. The customer's call to the service provider is routed to a customer service agent. The agent determines the nature of the customer's problem based on information disclosed by the customer. Assuming, for example, the customer is experiencing a DSL communication problem, the customer service agent may then select an option provided by the agent computer 602 corresponding to DSL communication problems. Responsive to selecting such option, the agent may be provided with flow chart components corresponding to a process for diagnosing and resolving a DSL communication problem. Steps corresponding to a current task are also provided to the customer service agent. The flow chart components and corresponding steps for diagnosing and resolving the DSL communication problem may be provided and updated as described, for example, in reference to steps 801-805 of the method 800.

Note that methods depicted in the exemplary flow charts described above may be modified to include fewer, additional, and/or different steps within the scope of this disclosure. Furthermore, steps depicted in the flow charts may be performed out of the order shown including substantially concurrently, in reverse order, or in a substantially different order.

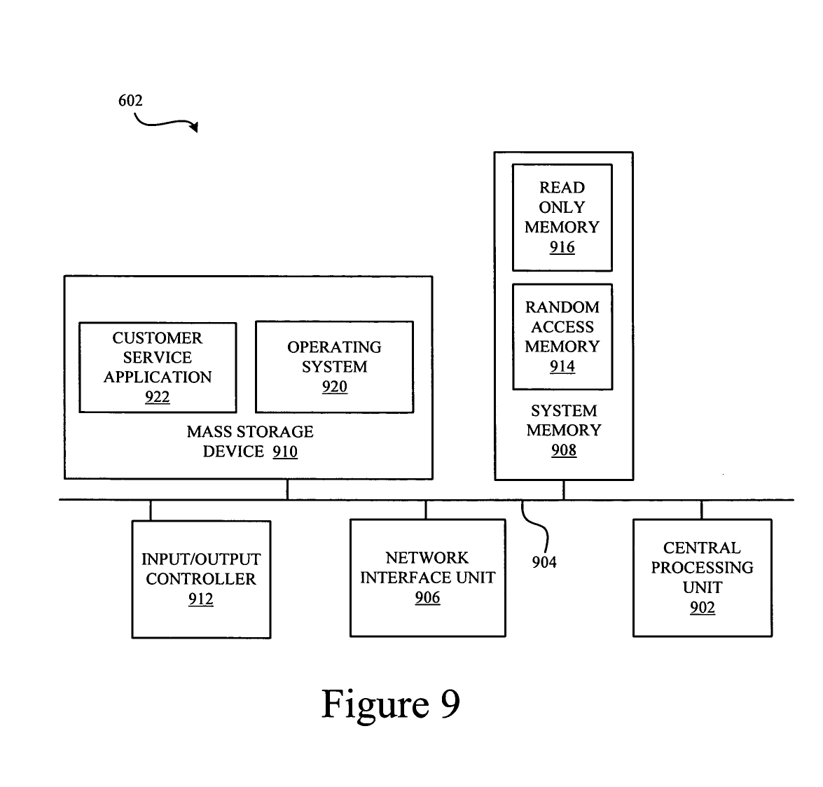

FIG. 9 is a block diagram illustrating the agent computer 602, in accordance with exemplary embodiments. The agent computer 602 may be, for example, an auto-configuration server (ACS) or part of an ACS system. The agent computer 602 includes a central processing unit 902 (CPU), a system memory 908, including a random access memory 914 (RAM) and a read-only memory (ROM) 916, and a system bus 904 that couples the memory 908 to the CPU 902. A basic input/output system containing the basic routines that help to transfer information between elements within the agent computer 602, such as during startup, is stored in the ROM 916. The agent computer 602 further includes a mass storage device 910 for storing an operating system 920 and other program modules, which will be described in greater detail below.

The mass storage device 910 is connected to the CPU 902 through a mass storage controller (not shown) connected to the bus 904. The mass storage device 910 and its associated computer-readable media provide non-volatile storage for the agent computer 602. Although the description of computer-readable media contained herein refers to a mass storage device, such as a hard disk or CD-ROM drive, it should be appreciated by those skilled in the art that computer-readable media can be any available media that can be accessed by the agent computer 602.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the agent computer 602.

The agent computer 602 may connect to a network through a network interface unit 906 connected to the bus 904. It should be appreciated that the network interface unit 906 may also be utilized to connect to other types of networks and remote computer systems. The agent computer 602 may also include an input/output controller 912 for receiving and processing input from a number of other devices, including a keyboard, mouse, or electronic stylus (not shown in FIG. 9). Similarly, the input/output controller 912 may provide output to a display screen, a printer, or other type of output device (also not shown in FIG. 9).

As mentioned briefly above, a number of program modules and data files may be stored in the mass storage device 910 and RAM 914 of the agent computer 602, including the operating system 920 suitable for controlling the operation of the agent computer 602. The mass storage device 910 and RAM 914 may also store one or more program modules. In particular, the mass storage device 910 and the RAM 914 may store a customer service application 922 configured to enable a customer service agent to provide customer service to a customer. Other program modules may also be stored in the mass storage device 910 and utilized by the agent computer 602.

According to exemplary embodiments, the customer service application 922 may provide a customer service agent with the user interface screen 100 that includes the flow chart section 102, the step listing section 104, the information section 106, and the image section 108. As discussed above, the step listing section 104 can list steps corresponding to one of the flow chart components 103. The flow chart components 103 may include components corresponding to a current task, a previous task, and a future task. Where a current task may lead to more than one possible subsequent tasks, the flow chart components 103 may include components corresponding to a current task and to the possible subsequent tasks, as will be discussed in more detail below.

The image section 108 can display an image corresponding to one of the steps listed in the step listing section 104. An image shown in the image section 108 may be, for example, a user interface window or a screen shot similar to what a customer is viewing during the customer service session. The information section 106 can display information related to the process corresponding to the flow chart components 103. The information in the information section 106 may identify, for example, certain tasks that were completed, the time the tasks were completed and/or the time taken to complete the tasks. Examples of the user interface screen 100 are provided in FIGS. 1-4. Note that the user interface screen 100 may have different configurations including fewer, additional, and/or different components than those shown in the Figures.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims. Various modifications and changes may be made to the subject matter described herein without following the example embodiments and applications illustrated and described, and without departing from the true spirit and scope of the embodiments, which is set forth in the following claims.

What is claimed is:

1. A computer-implemented method for enabling customer service through a user interface screen, comprising:
providing, in the user interface screen, a first portion of a flow chart including a flow chart component corresponding to a first task and a flow chart component corresponding to a second task, the flow chart corresponding to a customer service process;
providing, in the user interface screen, a list of steps corresponding to the first task depicted in the flow chart;
receiving user input indicating completion of the first task;
responsive to receiving the user input, providing, in the user interface screen, a second portion of the flow chart including a flow chart component corresponding to the second task and a flow chart component corresponding to a third task, the second portion having at least one flow chart component that is not part of the first portion; and
providing, in the user interface screen, a list of steps corresponding to the second task.

2. The method of claim 1, further comprising:
receiving user input indicating completion of the second task;
responsive to receiving the user input, providing a third portion of the flow chart including a flow chart component corresponding to the third task and a flow chart component corresponding to a fourth task, the third portion having at least one flow chart component that is not part of the first or second portions; and
providing a list of steps corresponding to the third task.

3. The method of claim 1, further comprising providing timing information corresponding to the first task responsive to receiving the user input indicating completion of the first task.

4. The method of claim 1, further comprising providing an image of a first user interface in conjunction with providing the first portion of the flow chart and the list of steps corresponding to the first task, the image of the first user interface corresponding to a first interface provided to a customer requesting help with a problem associated with the customer service process.

5. The method of claim 4, further comprising providing an image of a second user interface in conjunction with providing the second portion of the flow chart and the list of steps corresponding to the second task, the image of the second user interface corresponding to a second interface provided to the customer.

6. The method of claim 1, further comprising:
providing a user interface received from a server in conjunction with providing the first portion of the flow chart and the list of steps corresponding to the first task;
receiving user input corresponding to a selectable option in the user interface received from the server; and
transmitting an indication of the user input to the server.

7. The method of claim 1, wherein the second portion of the flow chart includes a flow chart component corresponding to a fourth task, and wherein the third and fourth tasks are alternative tasks to be performed responsive to an outcome of the second task.

8. A computer-implemented system for enabling customer service through a user interface screen, comprising:
a processor;
memory having instructions stored thereon, the instructions being executable by the processor and being configured to enable the system to:
provide, in the user interface screen, a first portion of a flow chart including a flow chart component corresponding to a first task and a flow chart component corresponding to a second task, the flow chart corresponding to a customer service process;
provide, in the user interface screen, a list of steps corresponding to the first task depicted in the flow chart;
receive user input indicating completion of the first task;
responsive to receiving the user input, provide, in the user interface screen, a second portion of the flow chart including a flow chart component corresponding to the second task and a flow chart component corresponding to a third task, the second portion having at least one flow chart component that is not part of the first portion; and
provide, in the user interface screen, a list of steps corresponding to the second task.

9. The system of claim 8, the instructions being further configured to enable the system to:
receive user input indicating completion of the second task;
responsive to the system receiving the user input, provide a third portion of the flow chart including a flow chart component corresponding to the third task and a flow chart component corresponding to a fourth task, the third portion having at least one flow chart component that is not part of the first or second portions; and
provide a list of steps corresponding to the third task.

10. The system of claim 8, the instructions being further configured to enable the system to provide timing information corresponding to the first task responsive to the system receiving the user input indicating completion of the first task.

11. The system of claim 8, the instructions being further configured to enable the system to provide an image of a first user interface in conjunction with providing the first portion of the flow chart and the list of steps corresponding to the first task, the image of the first user interface corresponding to a first interface provided to a customer requesting help with a problem associated with the customer service process.

12. The system of claim 11, the instructions being further configured to enable the system to provide an image of a second user interface in conjunction with providing the second portion of the flow chart and the list of steps corresponding to the second task, the image of the second user interface corresponding to a second interface provided to the customer.

13. The system of claim 8, the instructions being further configured to enable the system to:
provide a user interface received from a server in conjunction with providing the first portion of the flow chart and the list of steps corresponding to the first task;
receive user input corresponding to a selectable option in the user interface received from the server; and
transmit an indication of the user input to the server.

14. The system of claim 8, wherein the second portion of the flow chart includes a flow chart component corresponding to a fourth task, and wherein the third and fourth tasks are alternative tasks to be performed responsive to an outcome of the second task.

15. A computer-readable storage medium having instructions stored thereon, the instructions being configured to enable a system to:
provide, in a user interface screen, a first portion of a flow chart including a flow chart component corresponding to a first task and a flow chart component corresponding to a second task, the flow chart corresponding to a customer service process;
provide, in the user interface screen, a list of steps corresponding to the first task depicted in the flow chart;
receive user input indicating completion of the first task;
responsive to receiving the user input, provide, in the user interface screen, a second portion of the flow chart including a flow chart component corresponding to the second task and a flow chart component corresponding to a third task, the second portion having at least one flow chart component that is not part of the first portion; and
provide, in the user interface screen, a list of steps corresponding to the second task.

16. The computer-readable storage medium of claim 15, the instructions being further configured to enable the system to:
receive user input indicating completion of the second task;
responsive to the system receiving the user input, provide a third portion of the flow chart including a flow chart component corresponding to the third task and a flow chart component corresponding to a fourth task, the third portion having at least one flow chart component that is not part of the first or second portions; and
provide a list of steps corresponding to the third task.

17. The computer-readable storage medium of claim 15, the instructions being further configured to enable the system to provide timing information corresponding to the first task responsive to the system receiving the user input indicating completion of the first task.

18. The computer-readable storage medium of claim 15, the instructions being further configured to enable the system to provide an image of a first user interface in conjunction with providing the first portion of the flow chart and the list of steps corresponding to the first task, the image of the first user interface corresponding to a first user interface provided to a customer that is engaging in a communication session with the customer service agent.

19. The computer-readable storage medium of claim 18, the instructions being further configured to enable the system to provide an image of a second user interface in conjunction with providing the second portion of the flow chart and the list of steps corresponding to the second task, the image of the second user interface corresponding to a second interface provided to the customer.

20. The computer-readable storage medium of claim 15, the instructions being further configured to enable the system to:
provide a user interface received from a server in conjunction with providing the first portion of the flow chart and the list of steps corresponding to the first task;
receive user input corresponding to a selectable option in the user interface received from the server; and
transmit an indication of the user input to the server.
